(19) United States
(12) Patent Application Publication
(10) Pub. No.: US 2010/0106634 A1
(43) Pub. Date: Apr. 29, 2010

(54) SYSTEM TO ENABLE COLLABORATIVE INVESTMENT

(76) Inventor: Senake Atureliya, London (GB)

Correspondence Address: BROOKS KUSHMAN P.C., 1000 TOWN CENTER, TWENTY-SECOND FLOOR, SOUTHFIELD, MI, 48075, US

(21) Appl. No.: 12/444,307

(22) PCT Filed: Oct. 19, 2007
(86) PCT No.: PCT/GB2007/004017

§ 371 Date: Apr. 3, 2009

(30) Foreign Application Priority Data
Oct. 24, 2006 (GB) 0621199.9
Nov. 13, 2006 (GB) 0622593.2
Feb. 23, 2007 (GB) 0703549.6
Jun. 4, 2007 (GB) 0710595.0

(51) Int. Cl. G06Q 40/00; G06Q 10/00

(52) U.S. Cl. 705/35; 705/301

(57) ABSTRACT

A system adapted to enable plural forms of investment of resources by investors in a project preferably for a primary beneficiary, comprising a processor adapted to enable input by a primary user of one or more elements of the project, each element having specified properties and resource requirements, display to a plurality of investors of details of the project and the resource requirements of each of the elements of the project, and input by an investor of details of the availability of one or more of the resource requirements, the processor being adapted to determine allocation of each elements of the project to one or more investors.

Many good projects and business ventures with real value generating potential never get off the ground because of the unavailability of funds or resources. This means that innovation is stifled and the creation of wealth is limited to those with the resources to fund the projects and business ideas available to them. Currently whilst there are many communication channels available for seeking either loan or investment funding a number of key constraints still limit the fulfillment.

The lack of security combined with the difficulty in predicting the final outcome and therefore the profit and repayment potential of a project or idea is a major barrier. Investors are rightly worried about losing the resources they provide as well as potential profit. In addition to security, loan providers usually require the repayment of capital and interest which is not always available until revenues are created from the added value product or service.

Complexity is a second formidable barrier. Many project and business plans and projections are complex meaning that their full potential and risks can only be fully understood by parties with specialized knowledge. Moreover the complexity of data handling and interfacing with a large number of parties renders the analysis and implementation of such systems and methods extremely difficult to the extend that sophisticated computer implementation is required.

This invention defines a system and method that helps overcome these obstacles by reducing risk and lessening the effect of the knowledge barrier, as well as effecting possible computer based methodologies and schemes which are of genuine practicality. Aspects and features of the invention are set out in the accompanying claims as well as below.

Risk is alleviated by the system facilitating the definition of a plan detailing the required resources and their usage reducing the monetary risk involved and allowing investors and lenders to retain ownership of their resources or part ownership of the products or services to which they have added value. The plan allows the definition of returns which could comprise of fixed value and profit dependent elements together with their repayment dates.

To provide further security to investors and lenders in the event that the venture does not perform as per the investment usage and projected revenues the system will facilitate the creation of multiple reward scenarios that allow the inclusion of contingencies specified to compensate for the many possible unforeseen factors such as competitive behaviour or supply chain problems underperformance that could occur for a wide variety of difficult to accommodate reasons such as natural disasters or product obsolescence.

According to this investment structure invested items that are not consumed are secured upon themselves and those that are consumed would be secured upon an appropriate share of the product or service to which they add value so the rewards offered for underperformance would have to exclude these items.

The system would facilitate the inclusion of these risk alleviating rewards from the remaining value in the project such as the option for investors or lenders to retain agreed shares of the revenue or profits they could gain by operating a similar business or selling or renting part completed or finished goods and services upon which their investments were secured by being given access to the intellectual property and knowledge gained during the project together with the necessary licencing to utilise branding created and access the intellectual property rights owned.

The system provides users with the facility to create legal agreements based upon templates and the plan contents between those seeking resources and those offering to fulfill them.

The effect of the knowledge barrier is reduced by segmenting projects and business ideas into separate versions of the system or elements. Their specific definition allows requirements to be fulfilled directly by suppliers of the required product or service who usually have the specialist knowledge to understand its application. The lower monetary value of each requirement allows investors and lenders who previously did not have sufficient financial resource but who do understand the project or business plan to fulfill them.

Breaking down the resources in this way also creates the challenge of ensuring that the necessary resources or agreements to fulfill them when required are put in place before the project or business can proceed.

The system carries out automated processing using the algorithms and procedures detailed later in this specification to achieve the maximum simultaneous optimal fulfillment of requirements from live bids and predefined supplier catalogues with minimal or no manual intervention. Due to the complexity of this process which may depend upon selling the rights to future payments by trades people and suppliers to potential investors in an online, real time trading marketplace and the need to simultaneously create legal agreements whilst this situation exists it is unlikely that this function could be fulfilled manually as the system will electronically process the bids received by all of the parties in real time and carry out the trade to benefit all of the parties as defined in the system set up.

Where the system is set to accept bids from investors for future payment rights it would usually be configured to achieve the best price for the seller of the rights. Where the system is set to accept bids for funds offered by an investor it would usually be configured to achieve the highest value of future payment rights for the investor. The function of providing cost estimates based upon the interpretation of significant volumes of data in the system such as supplier catalogues and estate agent valuations in the case of the property development projects could not be manually carried out in the time required by potential customers and without incurring prohibitive costs.

As the consumer and business financing marketplaces are so competitive due to the easy comparison of products that has been facilitated by the intend and price comparison web sites the ability of the system to minimize any overhead is potentially very valuable.

In addition to optimizing the fulfillment of resourcing requirements the system is able to carry out similar automated processing to maximise the returns for investors and lenders by ensuring that their resources are generating the highest income possible.

Market research has shown that a multiplicity of investors or lenders may wish to provide required resources such as time or materials or assets or capital for use or consumption in the creation of added value products or services in exchange for a right to the repayment of a predetermined fixed amount and share of the profits generated by its sale or remortgage.

With conventional methods of investing, resources are generally pooled and managed by an appointed team of individuals. To reduce investment and lending risk the system proposed facilitate the more precise definition of the individual requirements that need to be fulfilled and the usage of fulfilling resources. This in turn allows an appropriate proportion of the created added value products or services to be allocated as security to the investor or lender to act as security until the predetermined fixed and profit share amounts are repaid to them.

The system allows a multiplicity of authorized parties to define the business or project that encompasses the creation of the added value products or services. Typically the parties that define the project will seek to resource it at minimum cost with the aim of generating the maximum profit for the project owners.

To minimize the share of profits offered to the investors and lenders the system the system may be configured so it is accessible to registered or unregistered users through a network linked to the Internet to allow offers to fulfill the requirements to be received from as wide an audience of investors and lenders as possible. Prior to each business or project stage being executed it is preferable that all of the required resources or the capital required to purchase them are obtained however where there is a good likelihood of unfulfilled requirements being fulfilled by the time that the resources are required the system will provide the opportunity to commence with only part fulfillment in place.

The fulfillment of each projects multiple requirements, elements, simultaneously represents a complex marketing requirement that cannot be fulfilled manually due to the speed of response required to legally bind a multiplicity of investing and lending parties into a joint contract before one or more of them withdraws their offer.

According to one aspect of this invention there is a network of electromechanical devices commonly known as computers or terminals that can communicate with each other to allow a multiplicity of users to share information.

Advantageously the system includes a network of computers, such as a server computer and networked client workstations which is adapted to enable activity within the system of different levels of user, and preferably a multiplicity of different user interfaces are included but not limited to screens and printed reports and email and text messages. Advantageously the system is implemented so that new forms of user interface can be added.

Preferably, trades people and suppliers need to have registered on the system if they wish to bid to fulfill requirements. As part of the registration process they are prompted to confirm that they have sufficient insurance in place to ensure that if they make an error that creates a cost or delay to another party the same get adequately compensated and the situation is rectified according to the conditions defined against each property or project plan. The system provides registered trades people and suppliers with the facility to define alerts enabling them to be notified of relevant investment opportunities using their preferred communications method such as email or text message or post.

According to another aspect of the invention the system allows a multiplicity of authorized users to input a business or project plan with the objective of finding other users who are willing to invest or lend the resources required to create a multiplicity of added value products or services in return for the right to receive a fixed amount and a share of distributable profits from their sale or remortgage.

Advantageously the system also allows potential resource suppliers to create and maintain an online catalogue detailing the products and services that they can offer together with their availability and the return that they are seeking.

Advantageously the system allows authorized users who have used or managed invested resources to allocate satisfaction scores to suppliers for different aspects of the fulfillment of a requirement such as quality and timeliness and attitude and management ability and resourcefulness and the ability of the supplier to work alongside other suppliers.

Advantageously the system also allows authorized users who have supplied resources to enter a satisfaction score against a business or project plan creator for aspects such as their timeliness of repayment and flexibility and attitude and project management ability and the competitiveness of their offered fixed amount and profit shares. Where the business or project plan creator is acting on behalf of one or more other parties the system would allow satisfaction scores to be entered separately for all involved parties.

According to another aspect of the invention the system allows potential suppliers to specify criteria to limit the investment and lending opportunities presented to them by any interface. These criteria would include but not be limited to the markets into which they wish to supply their resources and minimum satisfaction scores of all parties involved in defining the opportunity. Advantageously the system includes the option for authorized suppliers to define additional criteria as per their own personal requirements.

Advantageously the system allows suppliers to be able to list other suppliers with whom they do not wish to work and define whether this means that they do not wish to work upon the same opportunity or simply that they do not wish to come into contact with them or their resources or work. The system then takes these limitations into account when generating options for the optimal fulfillment of requirements and the investment of listed resources.

Advantageously the system allows each potential supplier to specify their preferred means for making and accepting offers. Some suppliers might wish to minimize manual intervention setting their account preferences to allow the system to create a legal contract when all of their predefined requirements are met. Other suppliers might wish to have the system use the catalogue to determine interest but then seek a manual acceptance of an offer by email or post. Other suppliers might wish to receive an email each time the fixed and profit share offer changes on a relevant requirement.

The system is able to accommodate all of these scenarios and others that are defined by authorized system administrators.

According to another aspect of the invention the system allows the definition of a lending structure for users seeking to provide finance for the purchase of resources that may comprise elements such as different lending tiers with interest rates offered being based upon factors such as the amount being borrowed and repayment periods and type of added value product or service or resource to be purchased.

Factors such as the salability of the purchased resource or added value product or service offered for use and or as security directly affect the risk and therefore both the decision to lend or invest and interest rate on offer, so according to another aspect of the invention the system also allows potential purchasers of products and services to create offers for and purchase them by detailing the prices that they would be prepared to pay to acquire them and quantities that they require. Advantageously the system conveys this information to investors and lenders and other interested parties because it effectively represents a reduced risk where there is a ready market for surplus value added products or services or invested resources.

According to another aspect of the invention the system generates initial fixed and profit share recommendations to offer in a defined plan based upon historic transactions for similar requirements and information available on current market values of the required resources.

According to another aspect of the invention the system allows maximum fulfillment to be carried out using the values stated in the catalogues that resource suppliers have created with the remainder of the initial fixed and profit share amounts being based upon the historic transacted amounts and current market valuations as detailed above.

Advantageously the system is able to accept a number of automated or manually input information feeds enabling the prices and profit shares and availability and other parameters that define both created plans and supplier catalogues to be continually adjusted to reflect current market conditions where desired.

According to another aspect of the invention the system has the functionality to allow a multiplicity of potential investors or lenders to register their interest in fulfilling a requirement and make counter offers detailing alternative fixed and profit share amounts against each requirement via a variety of user interfaces.

Advantageously the system repeatedly evaluates the offers that exist and adjust the offered fixed and profit share amounts maximise the fulfillment of the requirements by value or any other available measure at a frequency preset by authorized system administrators. The evaluation algorithms incorporated into the system consider the option of using invested or lent capital offering as defined in the finance supplier catalogues and investor offers to purchase required resources as well as direct fulfillment offers for each requirement.

Advantageously the system allows suppliers to specify a minimum investment or lending period that typically would be used to reflect whether a long handover time or delivery and installation cost is associated with the product or service.

Advantageously the system also allows the parties who have defined the business or project plan to specify minimum supply periods for each requirement that would typically be useful to minimize handover time or delivery and installation costs so that the system can take these into account when trying to fulfill a requirement using several invested resources.

Advantageously the system enables the plan creators to define minimum qualification levels based upon the suppliers satisfaction scores and other factors such that automatic fulfillment can be used with some degree of automated supplier qualification.

According to another aspect of the invention the system uses algorithms that seek to minimize the cost of fulfillment of each requirement by using the lowest cost resource that meets the minimum satisfaction scores specified in the plan followed by the next highest cost supplier and so on. These algorithms and procedures are detailed below.

Advantageously the primary users or project creators are also able to specify whether they want the system to display all of the available fulfillment options against each requirement ordered by any preferred criteria such as cost or whether they would like the system to automatically create contracts for the fulfillment parties that are identified as meeting the requirements at the lowest cost.

Advantageously the system allows the plan creators to set up alerts so that they are made aware of requirements that the system fulfills in this way so to remind them to change default settings and amend their plan criteria to increase or decrease this segmentation as required.

Advantageously the system allows authorized users to create potential investor and lender contact lists that the system would use to automatically generate offer mailings containing fixed and profit share amounts to maximise fulfillment. This facility would the same users to specify the investors or lenders that they wished to exclude from offers. In addition to contact details the lists would include information such as preferred contact method and frequency of mailings to help with the optimize relations by avoiding nuisance contact.

According to another aspect of the invention the system provides an electronic marketplace to facilitate the online trading of rights to the payment of fixed amounts or profit shares in exchange for funds. Rather than wait for sale or remortgage of the product or service the supplier may wish to receive immediate (or at a pre-agreed time before the end of the project or an agreed final payment date) payment to meet their expenses and other financial needs. As such they may be willing to trade a percentage of profits offered or awarded to them in exchange for receiving an immediate payment of specified amount of fund.

Advantageously this marketplace would be used by project creators looking for funding to purchase required items as well as investors and lenders looking to sell their rights to future payments.

Prior to a supplier offering to fulfill a requirement it is likely that they would want to know that they could cash in their chosen proportion of their rights to the fixed amount or profit share so the market would have to facilitate the creation of a contract allowing an investor to commit to a future purchase of rights before they are awarded to the supplier at an agreed price. The investors offer therefore needs to have been displayed alongside any requirements in the investment opportunities screen such that a potential supplier can agree to fulfillment confident on the basis that they can receive an immediate payment when their fulfillment offer has been accepted, when they have fulfilled the requirement or upon the fulfillment of any other criteria agreed by the supplier and the investor. The agreement between the investor and the supplier needs to be put in place at the same time as that between the project manager and the supplier.

The rights to a future fixed payment or share of profits from the sale or remortgage of the added value products or services created is in effect a new form of financial security similar to a zero dividend preference share in that no payments would be due to the investor until its maturity date. The minimum listed price of security would reflect the amount that the investor or lender requires plus any costs incurred in the creation of the security.

In the case of a value adding home improvement such as an extension creating extra living space the trades people and suppliers who contribute towards its creation will have received a right to a predetermined fixed payment and share of the profits generated by the home improvement to be paid out of revenues from its eventual sales or remortgage. Whilst each right is in effect a second mortgage being taken out on the property this situation differs in that the host property and the added value improvements are treated as separate properties with multiple mortgages being issued upon the improvement by the trades people and suppliers that have contributed towards its creation.

Unlike a traditional home improvement loan as the cost of the home improvement is restricted to just an offer of rights to a share of profit and does not include a regular repayment of capital or interest it would allow property owner occupiers who could not afford to finance additional payments to commission an improvement such as increased habitable space in exchange for allowing the trades people and suppliers who contributed toward its creation a share of the profits from the capitalization of its added value.

In some cases a property owner might wish to propose the creation of an improvement with a long repayment period. One example of this would be an extension of loft conversion to create additional bedrooms to accommodate an expanding family with a fixed repayment date that reflects when their children are likely to leave home. To increase the appeal of their proposed fixed amount and profit share offer, the property owner could optionally specify conditions for the repayment of the profit share such as a minimum value restricting its repayment when the market value was too low or setting of voluntary penalties for missing the date such as the investor being allocated more equity from either the improvement or the original property for each day by which the target date was exceeded. Where permitted by legislation and first creditors, this marketplace could also be used by property owners to directly to seek loans from investors and other providers with either regular monthly payments or the rights to sales and rental revenues secured against defined parts of their property. This functionality would be equivalent to a first or second mortgage being taken out direct with investors as opposed to a finance company.

It is envisaged that these securities would be attractive to a variety of individuals and organisations.

One group of investors who could benefit from holding these securities is potential first time buyers who are saving for a deposit. By investing their savings in these securities they could potentially create a hedge against property price rises that a savings accounts.

Other property investors could also invest smaller amounts in equity stakes over a variety of geographical locations rather than investing their combined larger amount in a single property purchase.

Investment banks specializing in the securitization of baskets of loans such as residential mortgage backed securities (RMBS) to create opportunities for investors looking to place larger amounts of capital could include these secured fixed payment and profit share rights in their investment offers. Advantageously the system would incorporate interface with the computer systems of participating banks to allow the automated analysis and acquisition of securities that were listed for sale. Advantageously functionality can be incorporated into either the system or the interfaced banking system to collate and bundle numerous listed securities together into investment classes or tranches as per predefined securitization structures to minimize the cost of creating the securitized products. It is envisaged that the securitized products would be attractive to existing bond investors who could potentially realize better returns in a low bank base interest rate market as the return offered would be based on property price growth rather than the mortgage rates that have followed the low prevailing interest rate. To avoid the potential for insider dealing or similar misuse, safeguards are put in place with disclosure requirements similar to those used in the securitisation market. The information provided by all rights owners to potential investors includes verifiable information such as council searches and property condition to ensure a fair valuation. Additional constraints with penalties for infringement are built into contracts to ensure that the property owner does not devalue the security by altering or misusing the underlying asset or parent property.

Whilst each security has a guide price based upon its current estimated market value its actual market value would be the worth placed upon it by individual potential buyers depending upon their predictions for the local housing market in the vicinity of the property.

Advantageously in addition to providing a marketplace for the trading of the securities the system seeks to convey as much relevant information as possible to the buyers and sellers that could contribute to the rise or fall of the value of the security such as information from news feed and estate agents valuations and sales and rentals completed and planning permission requests and the credit status of owners and tenants in adjacent properties and traffic flows and the creation of new properties and businesses that could improve or degrade the local area and more remote but relevant factors such as predictable events such as the payment of city bonuses which combined with historic information regarding the source of funds historically used to purchase properties in the area could have a similar effect upon the prices of the value of the parent property and security secured upon the added value improvement.

Advantageously the system assists the users in evaluating all of the available information by allowing them to quickly evaluate it when by allowing them to define one or more quick reference value indicators based upon the personalised weighting of each information feed that can in turn be used to create a personalized guide price alongside each investment opportunity.

Advantageously using information provided by these feeds the system is able to alert property owners and other potentially interested parties of the value and cost of improvements that could be carried out on their properties along with different payment options available.

According to another aspect of the invention the system incorporates an administrative interface allowing authorized users to define and display a charging structure for functionality provided to its users. It would be able to maintain accounts against each user to allow them to be invoiced and payments received for usage of the system.

Beneficially, the invention enables an investment to be provided in the form of the actual required asset usage, materials or labour; a key feature being that the system and method described enables an overall requirement to be broken down into elements at multiple levels ad infinitum allowing it to be fulfilled in the best way as defined by the users—most economical, fastest, highest quality or a combination of these and other factors; and to minimise risk by allowing the invested resources to be preserved in their most marketable, highest added value form; with the highest level of automation to minimise the cost, time and other negative factors associated with this task As an example of this functionality, if a defined project is the production of a number of chairs, investors could offer to invest either at a component level the wooden legs for the chairs or at a subcomponent level where the elements would be the wood required for their manufacture, the skilled machine tool operators time and the machine shop time on a lathe to allow the manufacture of the legs from the wood or even at a resource level such as an area of forest as opposed to simply providing the financial investment required to purchase the component and that the invested or lent items remain the property of an investor so that they are eventually returned to that investor or lender in either its original or transformed state. This can only be done where the resources are identified and tracked at the level described above.

The invention will now be illustrated, by way of example only, with reference to the accompanying drawings in which:

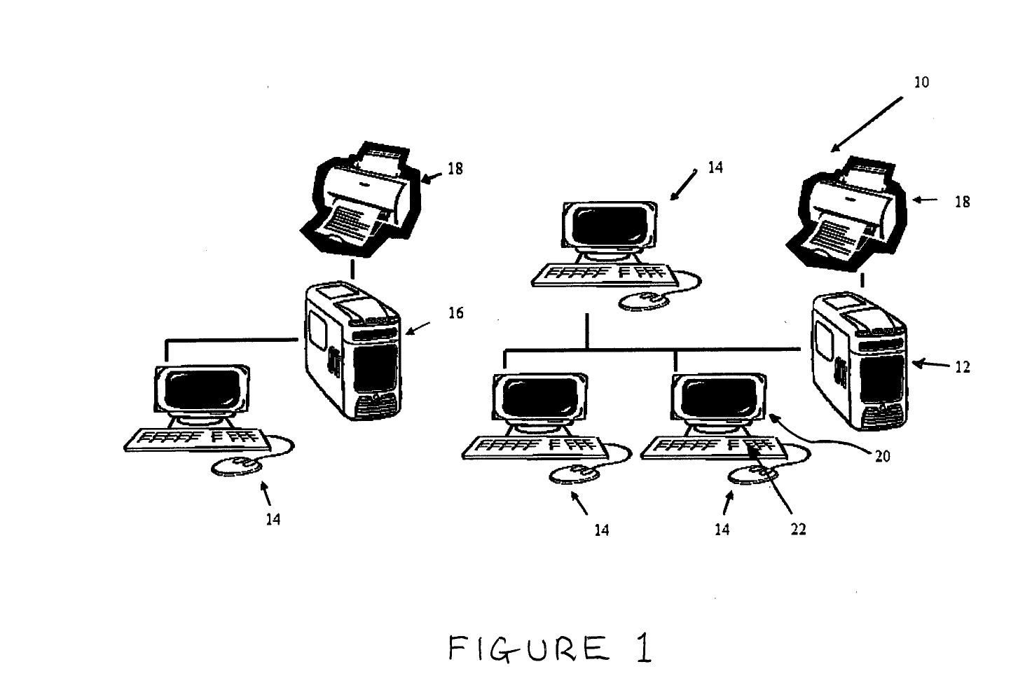

FIG. 1 depicts the basic hardware elements of the system and its users;

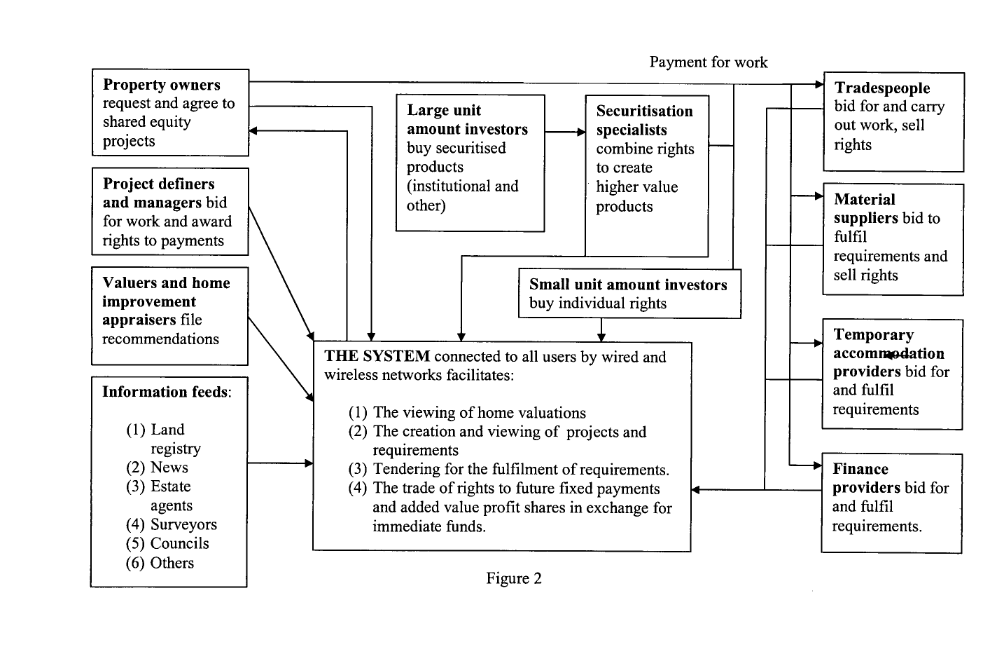

FIG. 2 depicts the main information and monetary flows between the system and its users;

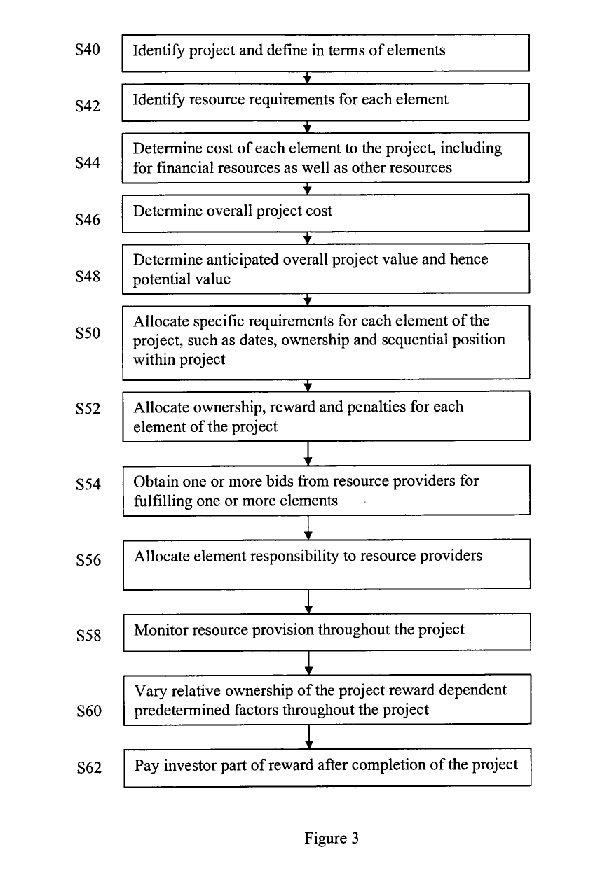

FIG. 3 is a schematic flow diagram of some of the steps in a method investing according to the invention;

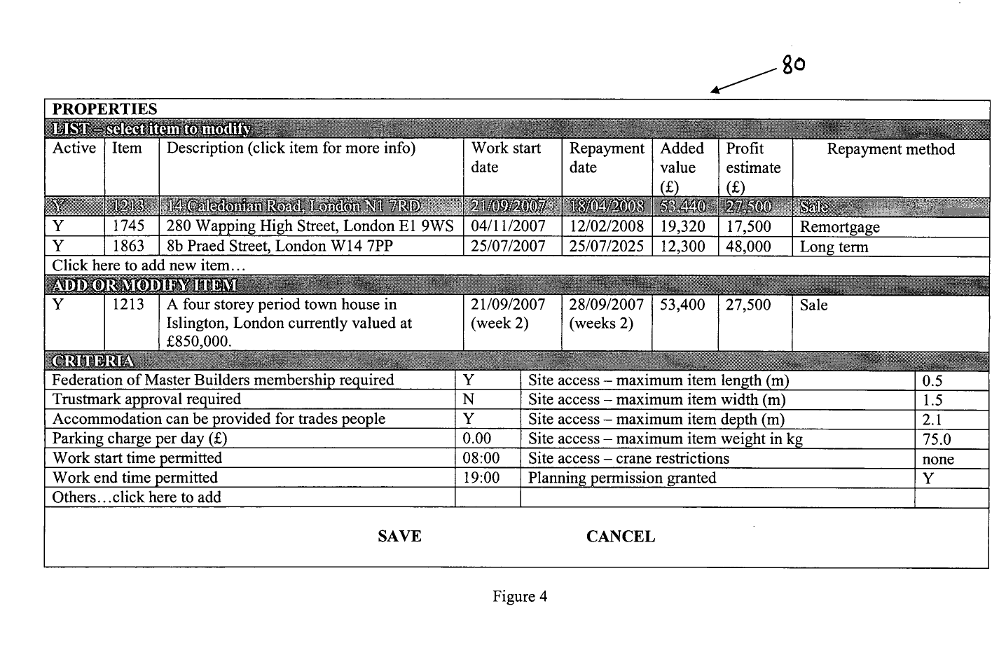

FIG. 4 shows one possible layout of the screen that allows users to list a property upon which value added improvement project proposals may be input;

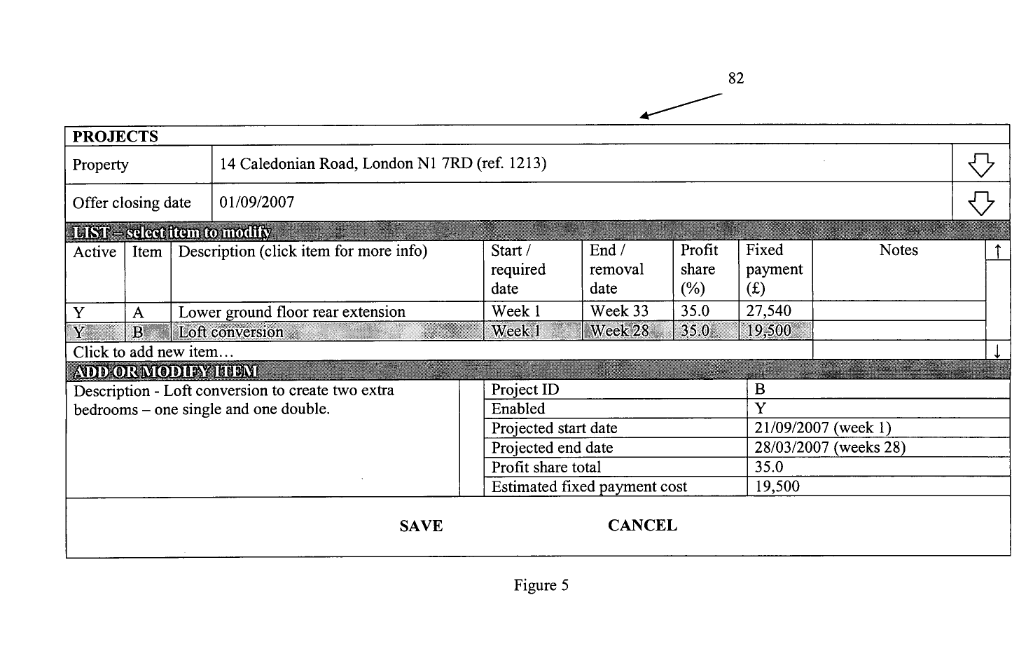

FIG. 5 shows one possible layout of the screen that allows users to list the proposed improvement projects for a property;

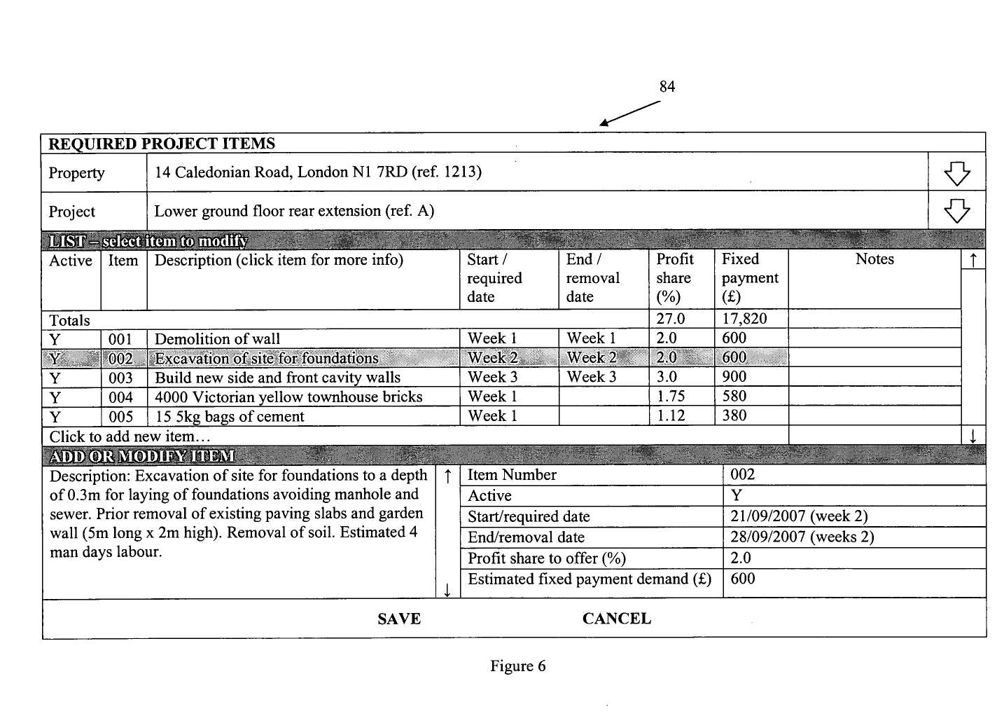

FIG. 6 shows one possible layout of the screen that allows users to list the required items required to fulfill an improvement projects

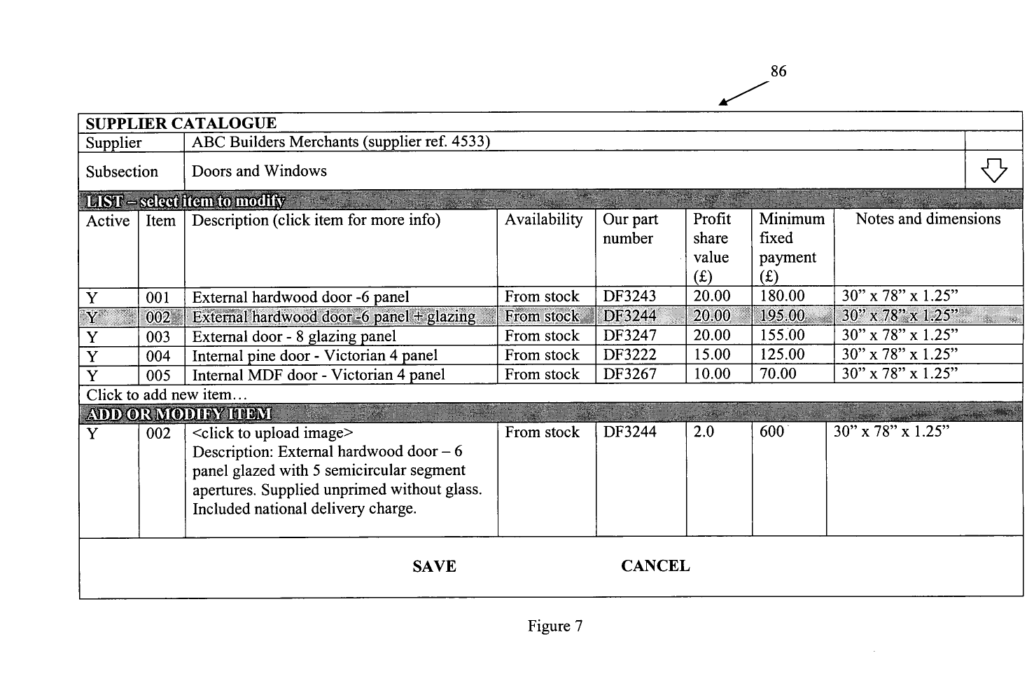

FIG. 7 shows a typical supplier catalogue definition screen detailing the availability and investment requirements for a building materials supplier;

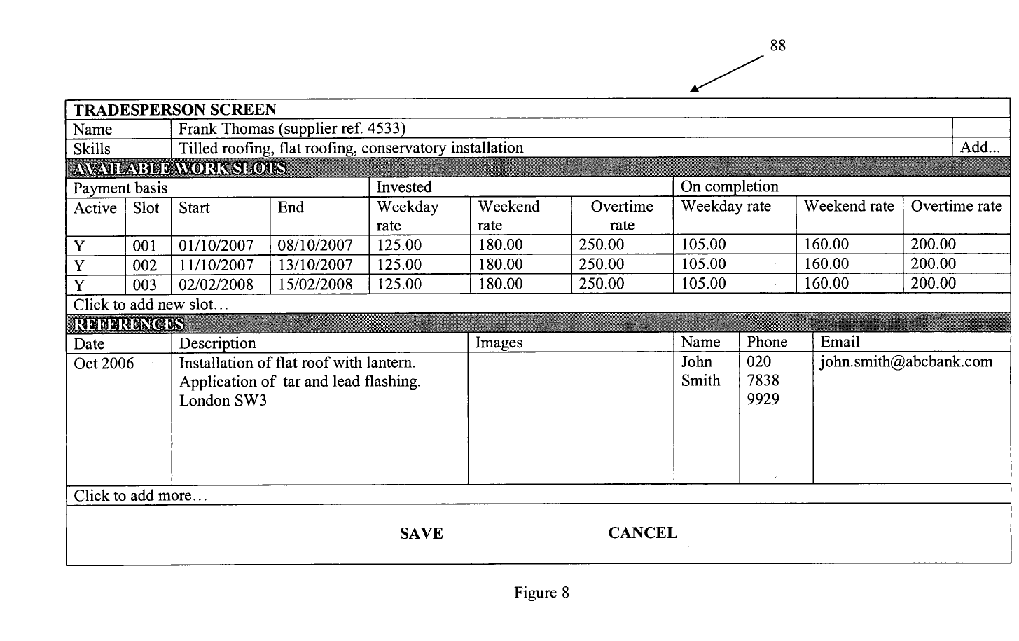

FIG. 8 shows a typical tradespersons screen detailing their availability and investment requirements;

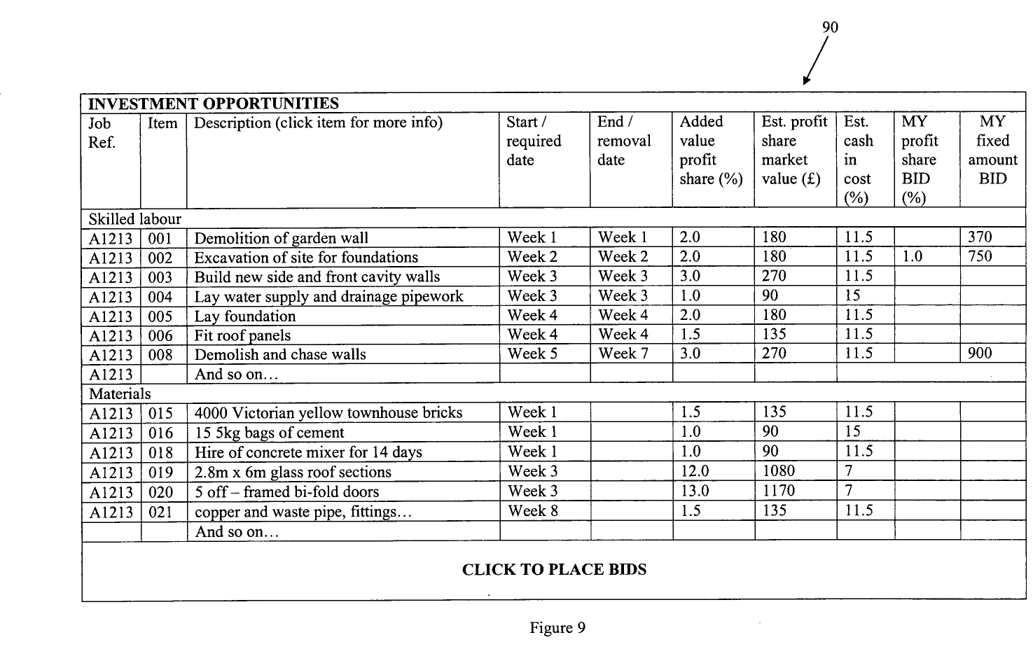

FIG. 9 shows a typical layout for the tender screen allowing suppliers to make offers to fulfill requirements;

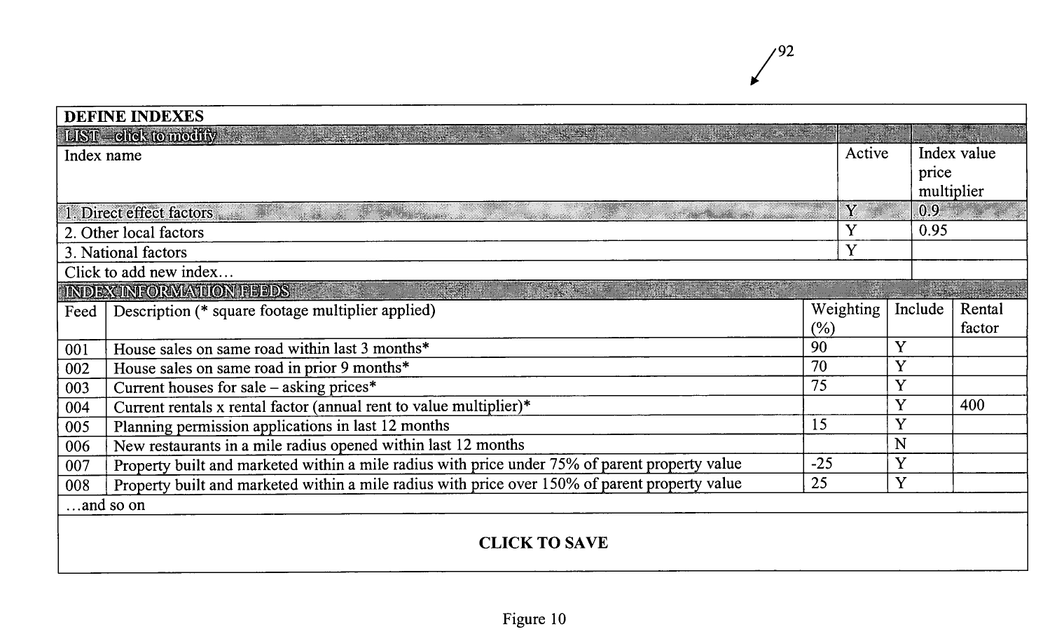

FIG. 10 shows a typical layout for the trading screen that allows investors to buy suppliers rights to future fixed payments and profit shares;

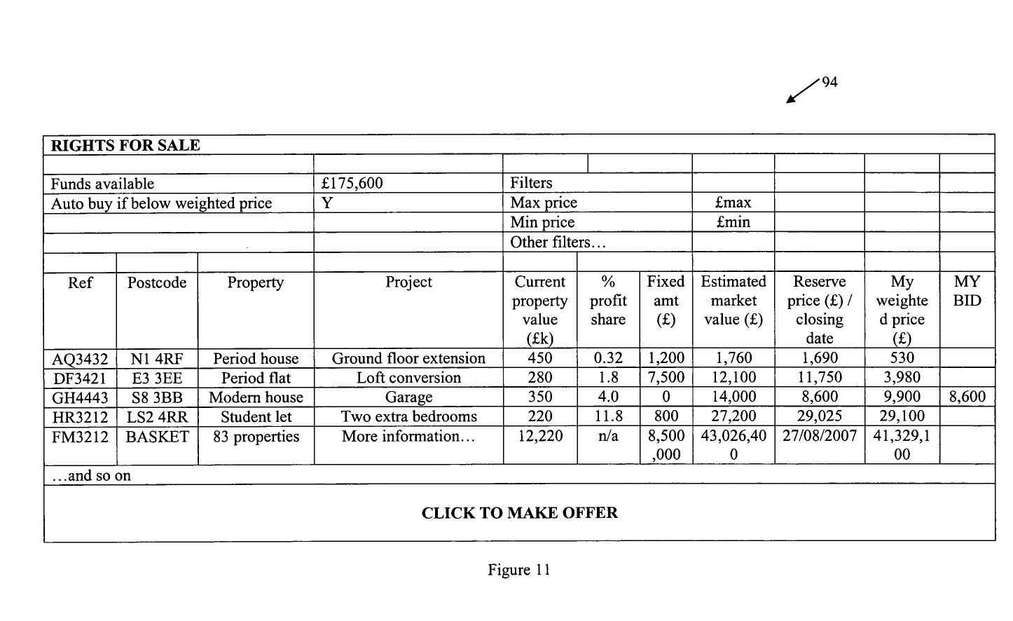

FIG. 11 shows a typical layout for the screen that allows investors to define their own external factor weighting indexes that is used to calculate the value in the personalized ‘my weighted price’ column on the rights for sale screen;

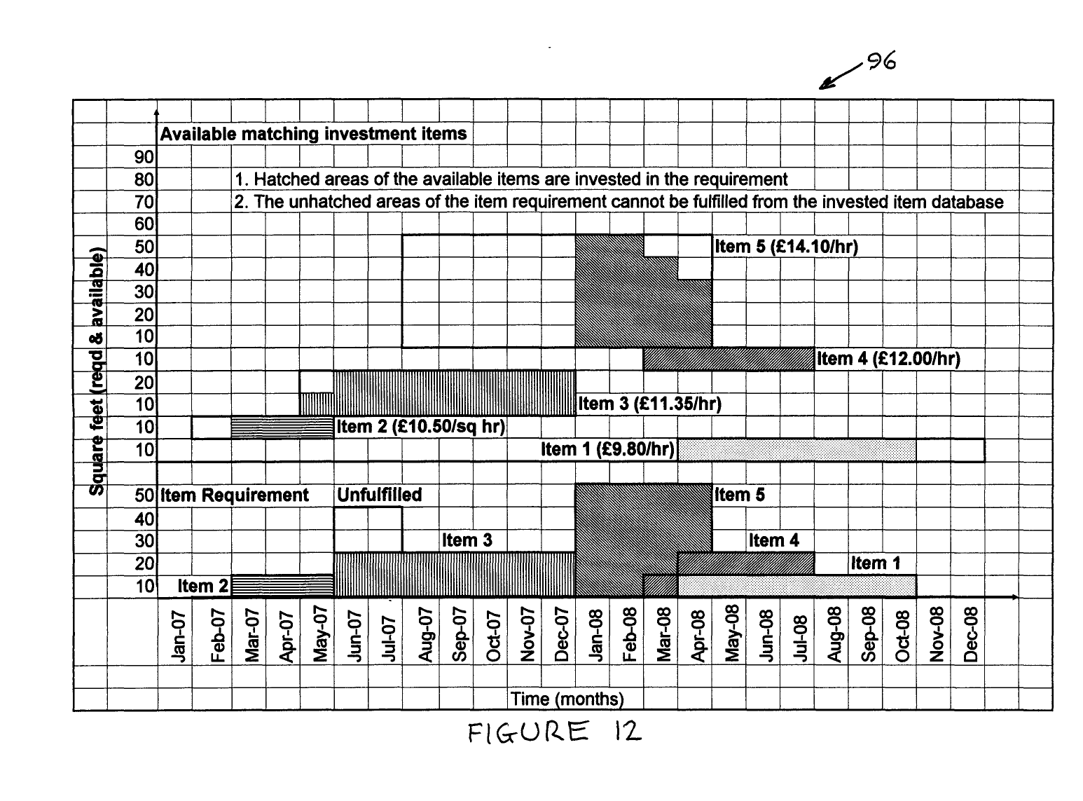

FIGS. 12 through to 14 shows the screen that the system uses to illustrate how the options for the automated fulfillment of an item requirement were derived to minimize fulfillment cost; and

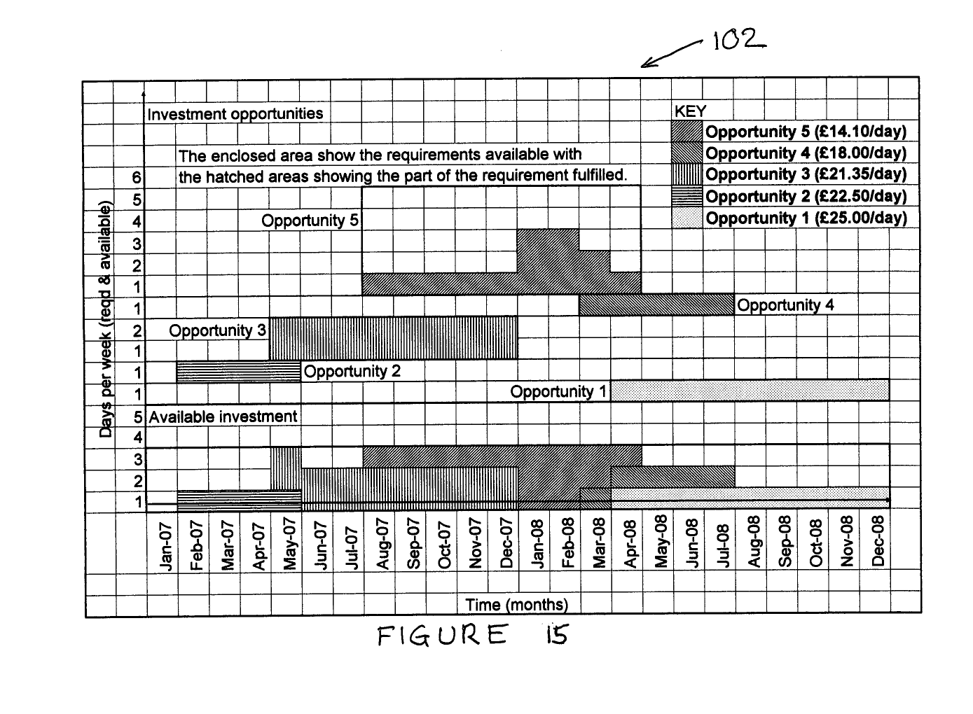

FIG. 15 shows the screen that the system uses to show suppliers how the options for the automated derivation of investment options were determined to maximise returns.

Referring to FIG. 1 the system defined in this specification resides on servers connected via a gateway into an network that is internal to the company operating the system. Printers and the computers or dumb terminals of internal users are connected to the servers via this internal network. The computers and dumb terminals of external users are connected to the internal network eg via wired or wireless intranet or internet networks via routers. The system will also have direct interfaces into the client-server based computer systems of external companies such as suppliers or information providers or securitization providers.

Information is held in a structured format known as a database on one or more of these computers so that it can be viewed or added to or modified or deleted by the users according to specific permissions allocated to them. The system would incorporate registration screens to allow users to input the necessary details about themselves and any companies that they represent and request the grant of specific permissions. In a preferred arrangement of the registration process a number of roles such as project manager and investor based around specific tasks that the system facilitates would be predefined to allow users to simply request a number of required permissions in a single action to let them carry out the tasks.

Referring to FIG. 1 in more detail there is a computer network 10 comprising a system server 12 connected via the network to plurality (here 3) workstations 14. Server 12 is further connected (possibly via the intend or other communications pathways including wireless communication pathways for example) to a remote server 16 which in turn is connected to work stations 14 (here one is shown). The workstations 14 provide a user interface with the system server 12 and via remote server 16 with a processor within system server 12 for effecting the functionality of the present invention. The work station 14 enable communication with various levels of users (such as beneficiaries or project initiators, project managers, investors (resource providers)) for example via printers 18, displays 20 and keyboards 22.

An overview of the functionality of the system is shown schematically in FIG. 2 wherein the system is represented by an enlarged block at the centre and also shown is some of the functionality of the system for the example of property (home or the building) projects. Accordingly, the system enables users connected to system server 12 to view home valuations, create and view projects and project requirements, tender for the fulfillment of the requirements (or elements of the project), and the trade of rights to future fixed payments and any value profit in exchange for media funds. Accordingly, a property owner (a beneficiary) is able to make a request in an agreed equity shared project with the project definers and project managers are able to interact with the system to bid for work and award rights to payment, valuers and home improvement appraisers are able to file recommendations within the system thereby to upgrade information contained against any project. The system is able to take, preferably automatically, information it needs for example from the Land Registry, news, estate agents, surveyors, councils and others.

Investors are able to buy securitised products via a securitisation specialist who group rights related to investments into similar risk profiles for higher value products by interacting with the system. Smaller units amount investors are able to buy individual rights (through investment and finance only) also by interacting with the systems. Other resource providers other than financial are also able to interact with the system and includes trades people in a bid to carry out work and/or sell rights, material suppliers are able to bid to fulfill requirements and/or to sell rights and temporary accommodation providers are able to bid and to fulfill requirements. Beneficially, finance providers are able to interact with all other resource providers and to interact with the system thereby to trade the resource requirements in any project.

Referring to FIG. 3, there is shown a schematic flow diagram of some of the steps involved in creating and running a project using the system according to the invention.

Accordingly, as shown in FIG. 3, at step 40 a beneficiary inputs a new project requirement onto the system. This example is shown with reference to the later drawings, the beneficiary might be an existing property owner wanting to create an extension thereby to improve the value of the property. The system enables a project definer, manager and/or the property owner (beneficiary) to define the project in terms of individual elements. At step 42, the resource requirements for each of the elements of the project are identified, possibly by the beneficiary themselves through interaction with the system and/or by the project definers/managers.

At step 44, the predicted cost for each element of the project including for financial resources, (such as interest rate payments as well as capital sums) are determined. Accordingly, at step 46 the overall project costs can be determined.

At step 48, the system determines, whether automatically or through input by a user the anticipated overall project value and hence potential value to investors (being related to the overall project value less the overall project cost).

At step 50, certain specific requirements for each element of the project are specified including timings and/or dates, ownership of the project, profit, and sequential position within the project thereby sufficient information to be presented to potential investors in order to determine the desirability of offering to fulfill (whether through funding or other resource provision) one or more elements within a project.

At step 52, the ownership rewards penalties and penalties are determined for each of the project elements and displayed to potential investors.

At step 54, the system is able to obtain one or more bids from resource providers (investors) for fulfilling one or more elements.

At step 56, the system allocates element responsibility to resource providers based on predetermined selection criteria such as lowest desired profit share.

At step 58, the system monitors resource provision throughout the project and enables updating of the project information.

At step 60, the system varies relative ownership of the project reward dependent upon predetermined factors such as fulfillment of the resource requirements of an element of the project (for example withdrawing any potential profit share from a resource provider) (investor who does not fulfill a requirement).

At step 62, the system is able to determine the relative amounts of payment for investors based on the reward after completion of the project.

Whilst some of these figures illustrate the potential layouts and key elements of some of the systems user interface screens the system will include additional screens and fields to collect other information as required. Advantageously the system will also incorporate user definable fields that may be placed on any of the screens to allow the display and manipulation of information as required.

In the case of individuals who own a property which they are considering selling, having seen an advertisement for a free home improvement appraisal, they can access the system via the internet and carry out their own research from other sources. This highlights that planning permission has been granted on neighboring properties to extend more that their own and it is likely that they can increase the profit from their sale by extending their property.

They register on the system and request a formal valuation and improvement appraisal online. A trained individual visits them to appraise their property and creates a report on the system that they log in and view. It estimates that the current market value is £500,000 and that they could further increase sale profits by adding a ground floor extension adding a guest bedroom, family room and shower room would add £50,000 in value and a loft conversion that creates an extra bedroom would add £35,000. It states that both these can be created for a cost of approximately £30,000 and £20,000 respectively and funded by a variety of means including that described above.

The owner decides that they will probably get conventional finance for the loft conversion allowing them to retain all of the additional profit generated, but they do not have sufficient equity in their property or confidence to borrow enough for the ground floor extension and cloakroom as well. They decide to list the ground floor extension project on the system.

The information pages on the system advise them that the risk of the cost exceeding the additional sales revenues would effectively be borne by the suppliers carrying out the build but in return for taking that risk they need to offer the suppliers rights to both a fixed payments and a share in the profit added by the extension that would need to be secured on its added value. As this is technically regarded as the creation of multiple mortgages on his property they are instructed to confirm that they have permission from their main mortgage provider before proceeding. The pages also advise them that by specifying an earlier rather than later repayment date for the fixed amounts and profit shares at market value, the perceived risk and interest costs to the suppliers is minimized making any offer more valuable and hence minimising the profit share that needs to be offered.

They feel happy to agree to fixed price payments and an initial offer of a 35% share in the profit generated by the extension when it is sold by an agreed date. As the online appraisal report indicates an estimated timescale for the completion time for the project of 6 months they decide to specify a repayment date of 9 months from the commencement of works to give them sufficient time to sell the property.

They enter these criteria into the system, request the necessary legal agreements. Although the system can be set to accept electronic confirmation of acceptance the administrator has set the system to generate and email out a copy of the agreement for the property owner to print then sign and return. The agreement commits him to into going ahead and details the penalties for withdrawing at each stage. On receipt of the signed agreement authorized staff administering the system log in and manually set an acceptance flag. Using the information from the valuation and home improvement appraisal the project is then advertised to qualified parties such as architects and architectural technicians and surveyors who can define and manage it in return for a share of the profits. Interested parties bid for the work and one is selected. They prepare plans and apply for planning permission where required. Once planning permission is granted they will define the project on the system using a screen similar to that depicted in FIG. 4 to detail the parent property and a screen similar to that depicted in FIG. 5 to list all of the projects to be funded and a screen similar to that depicted in FIG. 6 to define the necessary requirements for each project.

According to the example data shown in FIG. 6 the plan outlines that in weeks 1 the existing garden wall is taken down then the excavation for foundations is undertaken in week 2 and cavity walls around two sides of the extension are built in week 3 using bricks and cement delivered in week 1.

The system first seeks to fulfill as many of the requirements as possible from the online catalogues maintained on the system by registered suppliers using a screen similar to that depicted in FIG. 7 and the skilled labour availability calendars maintained by registered trades people using a screen such as that depicted in FIG. 8.

Interested parties indicated that they wish to fulfill transactions by view the relevant items on a listing screen similar to shown in FIG. 9 and entering the fixed fee amount they require and either accepting or counter offering on the proposed profit shares.

Suppliers who wish to ensure that they receive immediate payment upon fulfillment of their commitment list some or all of the rights to their future fixed payments and profit share on the systems online marketplace. They either set a reserve price for the rights which if exceeded will close the sale or set a closing date for bids. Interested investors either buy the rights or they remain unsold. Where they remain unsold the supplier either lowers the reserve price or makes a counter offer to the project manager for a higher fixed payment or profit share or decides not to bid for the work as it is not as worthwhile as initially thought it would be.

FIG. 9 shows that a supplier has offered to fulfill task 001 which is the demolition of a garden wall for £370 plus the offered profit share which has an estimated market value of £180 which would be reduced by 11.5% if cashed in immediately. Secondly the supplier have also offered to fulfill task 002 which is the excavation for foundations for seemingly higher fixed amount of £750 due to their perception that they could encounter problems from obstructions however they have conceded that they would reduce their profit share rights to 1% from the 2% offered. Thirdly the supplier has offered to fulfill task 008 for the demolition and chasing of internal walls for a fixed fee of £900 plus the profit share offered.

At the closing date for offers of the 1 Sep. 2007 as shown on the projects screen depicted in FIG. 5 only 83% of the requirements by value have been fulfilled using 92% of the predicted profit share and 81% of the fixed payment amounts budgeted leaving 17% of the requirements unfulfilled. The project manager reviews the list and determines that a further 5% can be fulfilled by increasing the profit share offered whilst still remaining within budget agreed with the property owner.

After requesting quotes from outside suppliers they determine that the minimum amount of additional funding required to purchase the remaining 12% of items on the open market is £1,650. After consulting the property owner on how they wish to fund this fulfillment shortfall the property owner decides to offer additional fixed payment and share of value added profits to interested financiers rather than take out a home improvement loan. The financing requirement is put out to both investors in the systems online rights marketplace. Both small private investors and securitization providers make bids on the rights based on their perception of its value and the rights are sold to a small investor. Had the securitization provider won the rights it would have rolls them up with other rights offers and loans and offers the more liquid securitized product to its larger investors. The larger investors would have bid on the securitized offering and acquired the rights. In the event that there had been no interest outside finance companies would have been approached and if there was still no interest then the property owner would have been advised that the project could not proceed until he raised finance to cover the shortfall.

When parties have agreed to fulfill all of the requirements that are necessary for the project to commence legal agreements are generated and copies dispatched to the relevant parties and work on the project commences. As materials and accommodation are supplied to specification and trades people complete their tasks as per the requirement specifications and fulfillment dates the project manager or property owner updates the required item status and they awarded the rights to their future fixed payments and added value profit shares.

When awarded, those shareholders who have contracted with investors to dispose of a percentage of their rights in exchange for immediate payment fulfill their contracts on the terms agreed. Other rights holders who have not previously made a contract decide what percentage if any the wish to cash in immediately and list them for sale in the electronic marketplace.

Registered investors bid on the rights to future payments and profit shares. The indexes that have defined on a screen similar to that depicted in FIG. 9 generate a quick reference personalized guide price next to each rights sale listed. When an investor places a winning bid the system generates a legal agreement that is emailed to both parties. When the seller of the rights has received the funds from the sale into their bank account they indicate this on the system and a new supplier legal agreement with the amended beneficiaries name is generated and emailed to the property owner.

Finally when the property is sold the rights holders are repaid the fixed payment and added value profit shares out of the sale proceeds.

Referring in more detail to FIG. 4, there is shown a display screen 80 of properties within the system according to the invention where each property is identified through an activity status indicator, a unique item reference number, and a description such as the address of the property. Also indicated in display 80 is a work start date, a repayment date, a perceived added value of the project to the property and an estimated profit. As can also be seen the repayment method such as sale, remortgage or long term, intended by the beneficiary (or project owner/property owner) also indicated thereby to give protection to investors an indication of the time involved in obtaining any profit share depending on the level of access for any individual user, a beneficial project manager is able to add or modify an individual property (or project item) by selecting one of their projects and modifying the criteria shown. Here, the requirements relating to the need for a builder to be a member of the Federation of Master Builders modified as indicated at the top of the variation criteria. Other examples of the project criteria which might include trustmark approval required, accommodation can be provided for trades people, parking charge per day and so on as indicated in FIG. 4.

Referring to FIG. 5, there is shown a display screen 82 of an individual project whereby elements of a project can be modified by an appropriate user and/or the project itself by a projected start and end date for example.

Referring to FIG. 6, there is shown a display screen 84 listing the required project items (or elements) of an individual project here referenced 1213 wherein each of the elements is itemised here from 001 to 005 including demolition of a wall through to 15 5 kg bags of cement. For each of the elements, a start date is entered, an end date, a proposed profit share and a fixed payment. Again, depending on the level of user, the element description and/or features can be modified via the user interface comprising display 84 as indicated in FIG. 6.

In FIG. 7, a supplier catalogue is shown in a display screen 86. Here a supplier (or resource investor) is able to specify features which are readily available from it including availability information, part number, profit share and value and minimum fixed payment required as well as other detailed information about the specific resource. Again, depending on the type of user interacting with the system, modifications can be made to supplier information if a user is authorised to do so.

A further example of a display which can be edited by a resource provider, here a tradesperson, is given if FIG. 8. The tradesperson display screen 88 shown in FIG. 8 enables a tradesperson to enter various information about that service provision. Accordingly, an investor such as a tradesperson can enter predetermined rates and availability which beneficially the system is able to capture such known suppliers and incorporate into a given project by the skills service or other investment of a supplier such as a tradesperson against an element of a project. This can be achieved automatically thereby enabling a project manager to select the tradesperson if appropriate.

In FIG. 9, a summary of investment opportunities is provided for an individual project, here project A1213 shown in some of the earlier figures. In display screen 90 of the investment opportunities, items 001 through to 021 are shown together with information including start date, end date, added value, estimated profit share, estimated cash and so on. Via display screen 90 an investor is able to bid for an individual element within a project. Referring to the last two columns of the table shown in FIG. 9, it can be seen that an investor is able to enter a profit share bid as a percentage and as a fixed amount bid (such as a value in pounds). Moreover the dates of the rewards for each of these bids can be specified either predetermined by the supervisor or in some cases by an investor and hence rejected or accepted as appropriate by an appropriate individual. Compensation can for example be immediate, on completion of an unurgent project, on completion of the overall project or that of a predetermined date before or after completion of the project.

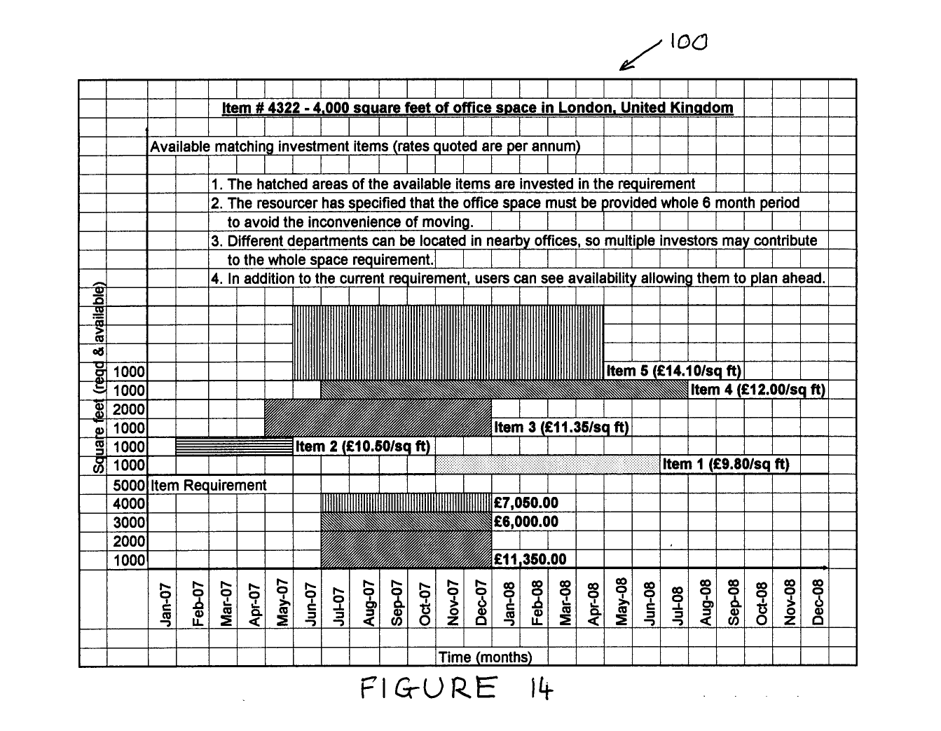

FIGS. 11 through to 13 depict data on process screens that illustrate to project managers how the algorithm used by the system process has sought to optimize the costs of fulfilling requirements from available invested items. FIG. 14 depicts a screen showing how a similar algorithm has sought to maximise the return on invested items.

The algorithm divides up available invested items into predefined base time and quantity units and loops around to match these to required item requirements applying the lowest unit cost invested items to each requirement first and then progressing onto incrementally higher cost invested items.

Using this method it can determine and if the selected by the project manager the system can display all of the possible fulfillment options ordered by cost to fulfill a required items defined duration or quantity.

The algorithm for the maximization of investment returns follows a similar logic but divides up the requirements into basic time and quantity units. It then loops around in a similar way to allocate the highest paying requirements to the invested items available time slots first progressively then progressively the lower paying ones. That is:
1. The process will loop around all of the catalogues and availability schedules maintained by equipment, materials, premises, skills and other resource suppliers that fulfill any particular requirement ordered by cost increasing.
2. It will then allocate all of the available the lowest priced resources first.
3. It will then successively allocate all of the available the higher priced resources incrementally until the requirement is fulfilled.
4. Where a requirement was for resource provision over a period of time as opposed to a delivered item (eg. manpower, premises or equipment as opposed to raw material, the system would slice up the requirement into basic time units (hour, day etc.) and loop around to fulfill the requirement at minimal cost within each time unit.
5. The process for maximizing investor returns is very similar except that available resources and requirements exchange places in the process.

FIG. 11 depicts data on the screen showing how the system has derived options for the fulfillment of a requirement for book keeping services. As the task does not involve a lot of handover between fulfilling parties its cost can be optimized by selecting the lowest cost available invested resource. The blocked area in the lower part of the screen depicts the number of hours and periods during which they are needed. Matching investment items available numbered 1 to 5 in the figure are shown above ordered by hourly cost per unit. The screen highlights an unfulfilled requirement of 20 hours per month in June and July 2007. The unshaded portions of the invested item areas also highlight the available services that are not invested in the requirement.

FIG. 12 depicts data on the screen showing how options for a similar to that shown in FIG. 11 for warehousing space in Bristol were derived. Due to the nature of the requirement the project manager decides that products can be easily delivered to a limited number of local managed warehouses just as easily as they can be to a single one. This allows the same cost optimization methodology where invested resources can be split by both duration and quantity for application sequentially and in parallel to a requirement.

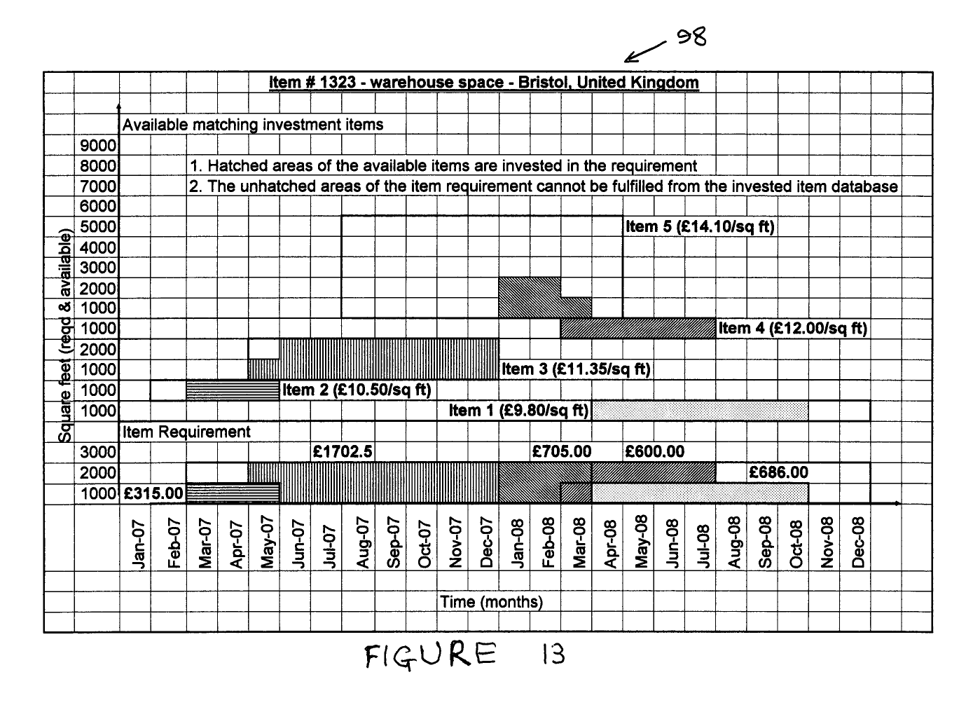

FIG. 13 shows data on the screen detailing how the options for fulfilling a requirement for office space in London were derived. As the project manager has specified that they cannot suffer the inconvenience of moving the lowest cost option which is only available for a period towards the tail of the requirement cannot be allocated. The project manager has specified that they are willing to consider the location of individual company departments in separate but closely located offices allowing the requirement to be fulfilled more economically by dividing it up between a number of smaller offices available on a lower cost basis than the larger office that could fulfill the whole requirement.

FIG. 14 shows the data on the screen displaying how options for the maximisation of the return on an investment were derived by applying it to the requirements with the highest rate of return first. The user interface is particularly beneficial here.

### User Interface

This interface can be used to optimise purchased as well as invested items. The system uses algorithms to create the lowest cost options for multiple invested items to fulfill (1) a required item duration (2) a required item quantity (3) both item quantity and duration requirements. A similar process is carried out to allow the maximisation of returns for invested items that can be used to fulfill multiple resourcing opportunities.

### As a Resourcing Screen

A screen can be used by a project manager or entrepreneur looking to fulfill a requirement for accountancy resources; wherein
(1) Requirement—the blocked area in the lower part of the screen depicts the number of hours and periods during which they are needed. In a similar way, this could show requirement materials, asset usage or another manpower requirement.
(2) Matching investment items (1 to 5 in the diagram) are shown above ordered by cost per unit (in this case hourly). In the case of invested items, this cost encompasses the fixed fee, delivery and retrieval charge and a period of profit share.
(3) The diagram illustrates how the lowest cost items offered are applied first to fulfilling the requirement followed by the successively more expensive items.
(4) The diagram illustrates any unfulfilled requirement such as the 10 hours per month in both June and July 2007. It also illustrates the unused component of the offered investments such as the last two months September and October 2008 for invested item 1.

### As a Investment Screen

A screen can be provided to enable the marketing of spare accountancy resource by either a firm of accountants or another company who's full time book keeper is under utilised.
(1) Available investment—the blocked area in the lower part of the screen depicts the number of hours and periods during which the spare accountancy hours are available.
(2) Matching item requirements (items 1 to 5 in the diagram) are shown above ordered by the maximum price that they are willing to pay per (in this case hourly) unit—in the diagram, the amounts are shown for the resourcing example above (decreasing from bottom to top), but for the investment optimisation screen the item requirements with the highest investment returns would be shown first (increasing from bottom to top). This return is made up of the fixed fee, delivery and retrieval charge and a period of profit share offered.
(3) The highest return opportunities would be fulfilled first followed by the successively by those with lower returns.
(4) In a similar way to the entrepreneur, the diagram would show any unused, but available investment such as the 10 hours per month in both June and July 2007 shown with the question mark against it. It also illustrates the unused component of the offered investment such as the last two months September and October 2008 for investment item 1.

By way of a further example of the invention, An individual (the resourcer) based in the United Kingdom is looking to try and launch a new type of children's swimming aid in the form of a piece of children's day clothing. Whilst the individual has obtained some pending patent protection rights for key elements of the product they cannot afford to take out, maintain or defend the patents unless the product sells in the projected quantities. Patent infringement in the novelty plastic goods sector is common and many of the competitors with their own factories and existing supply chains could bring product to market within 6 to 8 weeks once they had seen a competitive product selling successfully.

Having shown a prototype and canvassed existing large wholesalers supplying just the seaside holiday resorts in the key US, Pounds sterling, Australia and Asia markets, they have committed to initial fixed orders of 10,000 units and predicted demand for 18 million units in the launch summer season if it can be sold below the 10 Pounds sterling retail price point. Alternatively, at a higher price point of 20 Pounds sterling, they committed to reduced initial orders of 1,000 units and projected sales volumes in a premium market of 2 million units mainly due to competitor domination of the mainstream market albeit with less attractive products selling at between 5 to 10 Pounds sterling. None of the wholesalers was willing to place orders at a retail price point of over 20 Pounds sterling.

The 10 Pounds sterling retail price point gives a maximum wholesale price of 5 Pounds sterling and an estimated ex works packaged price including profit of around 4.50 Pounds sterling after shipping and distribution. Based upon the quantity of 10,000 units, the lowest budget quote for the moulded product including low volume tooling was 6.50 Pounds sterling with packaging costs coming in at 50 cents per unit giving a LOSS of 2.50 Pounds sterling per unit or 25,000 Pounds sterling for the batch.

The 20 Pounds sterling retail price point gives a maximum wholesale price of 10 Pounds sterling and an estimated ex works packaged price including profit of around 7.50 Pounds sterling after increased low volume shipping and distribution costs. Based upon the lower initial batch of 1,000 units, the lowest budget quote for a short run moulded product including low volume tooling was 26 Pounds sterling with packaging costs coming in at 1.50 Pounds sterling per unit giving a LOSS of 20 Pounds sterling per unit or 20,000 Pounds sterling for the batch.

To break even at the 4.50 Pounds sterling ex works packaged price based upon the lowest budget quotes received, including high volume tooling, a commitment to order over 2 million units was required. The units could be called off in batches of 10,000 units or more over a 12 month period. To achieve a 3.50 Pounds sterling manufacturing cost and generate a profit of 1 Pounds sterling per item, the annual order commitment had to be 6 million units. At the predicted market size of 18 million units, the manufacturing cost based on the lowest quotes received was just 1.50 Pounds sterling giving a profit of 3 Pounds sterling per item or 54 million Pounds sterling in the first year.

To maximise the revenues that could be generated it was necessary to aim for the lower price point and 18 million volume sales before competitors could enter the market with similar offerings. Having analysed entry into the market at the 20 Pounds sterling retail price point in a similar way, it was decided this ‘halfway house’ approach would give a significantly lower return on investment and was not considered worthwhile if investment was to be sought to pursue the volume route.

As part of phase 1 of the project, an industry specialist working under a confidentiality agreement carried out due diligence on the individual's business plan and projections.

As part of phase 2, the resourcer had the product designed, prototyped, tested and optimized for production.

Now the in phase 3, the resourcer is looking to launch and grow sales of the product in the marketplace.

The plan outlines the need for manufacturing ideally in a low cost base location and a supply chain complimented by effective sales and marketing.

The product consists of a single non standard plastic injection moulded component and packaging comprising of a standard size plastic bag and specially printed cardboard bag closure with shelf hanger slot.

The resourcer defines the project phase containing a list of the required resources on the system together with a guide rewards on offer to parties fulfilling each requirement. The rewards themselves comprise of a fixed amount, a profit or revenue dependent amount (that would become payable once sales revenues had been received on the swimming aids that they had helped to fund) and the security/reverse royalty terms. The system default for the security terms is that the suppliers retain ownership of their assets at all times even when they have been transformed or incorporated into a product alongside other components or materials. The is also a standard reverse royalty term that defines a sliding scale of rights to suppliers on the underperformance of the project such that they are awarded rights to intellectual property and other project information that would give them the option to try and commercially exploit the opportunity on payment of royalties to the original resourcer.

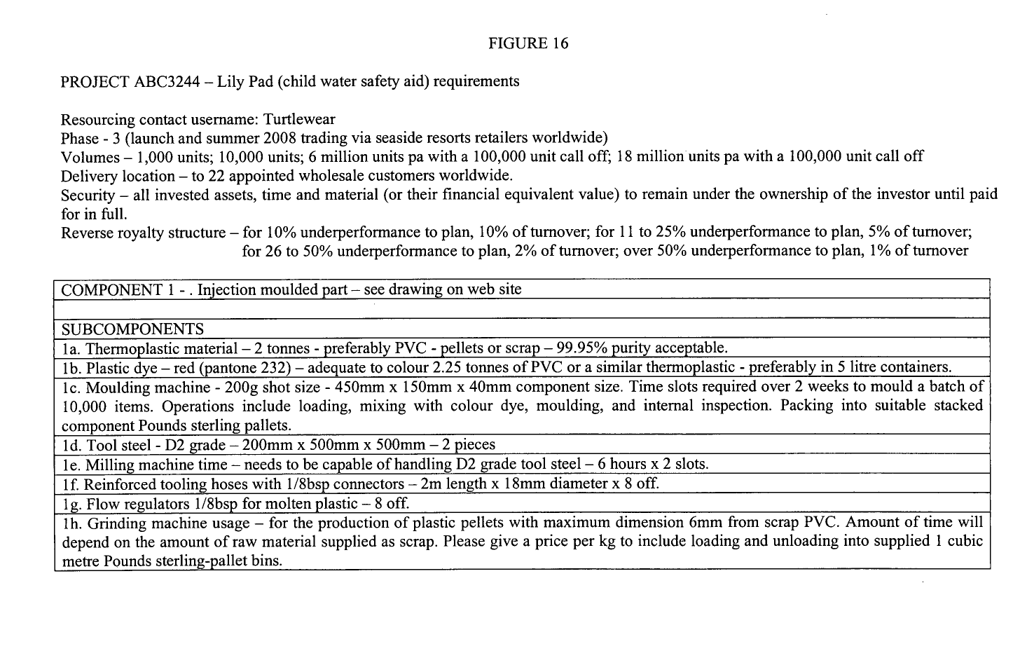

In this example, each requirement is input into the system manufacturing projects template. The system has a number of templates that have been defined to suit different business models and markets. The templates prompt the resourcer to break down the specialized components into resources to maximise the possibilities for parties to be able fulfill each requirement cost effectively resulting in a requirements list. The entry for each component would look something like that shown in FIG. 16.

As depicted in FIG. 16, batches of injection moulded parts are expressed as the components themselves as well as being subdivided down into the total quantity of scrap thermoplastic, use of the recycling machine to break the plastic down into chips (if it proves more cost effective to process scrap), time on a suitable moulding machine to mould the components, a quantity of tool steel, machine shop time to produce the tool and other standard components required to produce the injection mould tooling. The plastic chips requirement proposes a returns option allowing unused chips or the components from unsold product to be returned in exchange for a pre-agreed credit.

In addition to the component shown, there would be other components, packaging and required services such as assembly, warehousing, transportation, logistics management and marketing are listed tightly defined with timings, quantities and other vital specifications. Where possible, these would also be broken down in a similar way. The cardboard closure for the retail cellophane bag could be expressed as a single component or a quantity of cardboard blanks, printing inks and time on a suitable printing press.

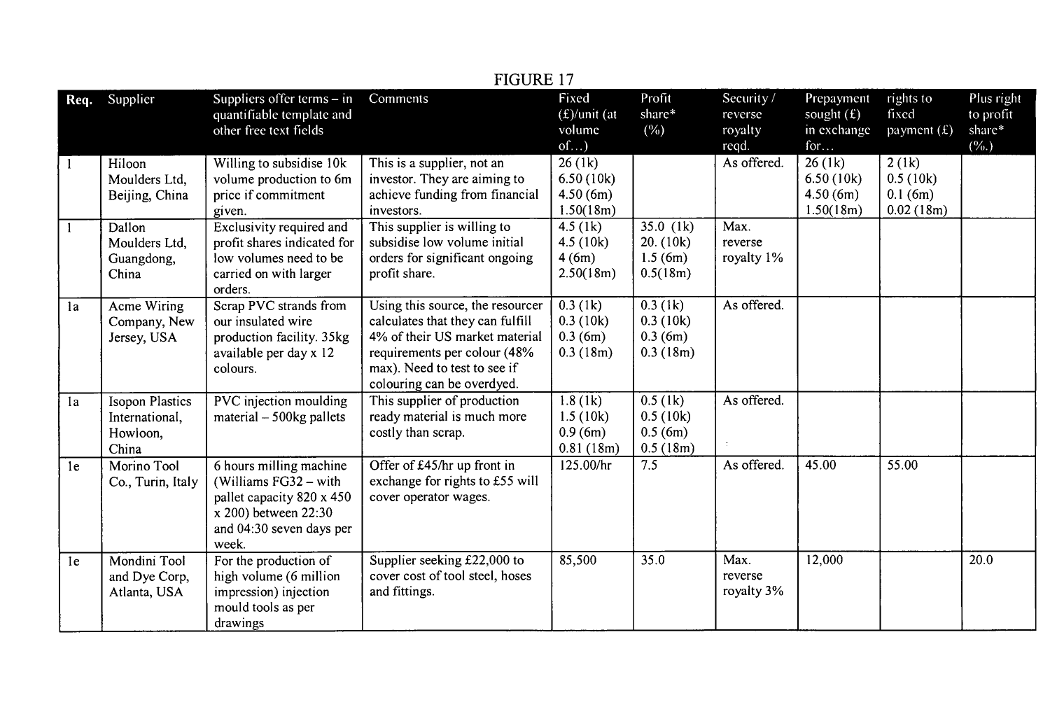

A sample of the automated and manual quotes received are shown in FIG. 17.

As they cannot be sold to another customer the specialized components represents a high risk to a potential investor. The risk is reduced by opening up the requirement up to a much wider audience who can make their own decisions on pricing and quantity options. Instead of just moulding chip suppliers bidding to supply chips, any supplier with suitable surplus or waster plastics can bid to provide this raw material. Machine and moulding shops can offer unbooked time slots to mould the components. Similarly, the other service providers can bid to fulfill the requirements utilising any un-booked slots that they may have. When the individual has defined the project and requirements, the system matches each requirement against the registered bidders on the system.

In this case, the system will evaluate the financial cost of the offers made against the requirement 1 for the whole moulded product alongside those made to fulfill the constituent requirements 1a to 1g. This evaluation will take into account the negative or positive weighted financial adjustments that the resourcer wants to apply to account for factors such as each suppliers job fulfillment history and references, their credit rating, included services, size and location.

Once it has calculated all of the fulfillment cost options, it will combine these and include additional costs such as transportation, insurance and administration to derive the best fulfillment offers that maximise fulfillment whilst minimising cost. It will then evaluate the additional funds required to purchase resources on the open market from registered and vetted suppliers where possible and issue requests for quotations. Once these have been received, it will calculate the direct financial investment required, list it on the financial investment opportunities screen and send out communications to registered financials investors whose investment criteria match those of the project.

The resourcer will have specified whether they want to be notified when they have offers to fulfill all of the requirements below a target amount. If they have opted to receive this notification, they can then either issue and receive signed agreements to close the auction or issue a revised closing date to encourage last minute improved bids.

Most of the mainstream financial exchanges such as the stock markets operate on a continuous bidding basis during their daily opening hours. Participants are able to place bids to buy and sell assets at any time. Liquidity is increased by the system allowing upper and lower limits to be set to allow transactions to be automatically carried out when the buyers or sellers conditions are met.

The system defined in this invention allows either method—closed or open bidding—to be set for the each type of bidder independently. Closed bidding is where bidders cannot see each others bids and this format has been provided to accommodate the preferences of the market where opposition to open auctions exists—examples include heating engineers and their professional representative body who banished it by arguing that it led to lower overall quality and working standards.

Potential product and service providers registering on the system will be prompted to specify details of the products and services that they offer and ideally create an online product catalog or services availability schedule with prices. They will also be able to define criteria allowing them to automatically place bids.

In addition to simple geographical, financial, quantity and delivery time based criteria they will be able to specify parameters defining acceptable levels of risk against a framework defined in the system. This framework will include standards for industry specialists who have carried out the due diligence as well as other parties budding upon or already involved with a project. The system operators will be able to produce additional risk assessment information that can be represented upon the framework by extracting information from external sources such as news feeds and the financial markets that can also be interpreted by the system when applying the users automated bidding criteria. The system will allow access to authorized third parties via predefined interfaces to allow them to update their online catalogues, automated bidding criteria or even allow them to maintain additional risk assessment information relating to their information sources. Transport companies will maintain online price lists for the international and national carriage of goods. Product and service suppliers will be prompted by the system to detail the territories in which they are willing to work together with pricing variations related to each location.

The system will first determine the alternative transportation cost options for each batch of components, finished and packaged products that needs to be moved between potential raw material suppliers, manufacturers, contract packers and the distribution centres of those wholesalers registered on the system who distribute product to the retail locations specified in the business plan based upon the sales volumes projected in the project plan.

Research has shown that whilst there are many suppliers and contractors willing to accept investment risk in exchange for a greater return, this number could be significantly improved by providing an option for some funds to be paid up front to meet immediate costs when the rights had been awarded rather than when funds became available to pay them. To facilitate this requirement the system also provides an interlinked marketplace to allow the suppliers and contractors to sell some of their rights to future payments to financial investors in exchange for immediate payment on receipt of the rights.

If they have enabled automated bidding, the system will calculate the cost of fulfilling the project requirements using the online catalogs and schedules maintained on the system.

For registered bidders who have opted for manual bidding only the system will send out a communication containing either complete details of the investment opportunity or a link to their opportunities screen where they can see details of the opportunity.

They will be prompted to enter a bid using any of the communication methods supported by the system by the bid closing date detailed in the project plan. They will be able to enter details of the fixed amount, profit share element, offer conditions and other information (see next paragraph) that they would like in exchange for fulfilling the requirement.

Both the manual and automated bidders will be able to specify either the absolute amount or one depending on the bid and other factors that they are seeking from a financial investor in advance of the repayment date together with their payment date preferences and the future fixed payment and profit share rights that they are offering in exchange.

In a similar way to the product and service suppliers, registered financial investors will be notified of investment opportunities that meet their financial, geographical and other investment criteria. Using the trading screen they will be able to accept or make counter offers to satisfy the needs of both the resourcer and bidding suppliers. The situation is mad more complex as these investors will be able to bid for future rights from competing suppliers who may be bidding to fulfill the same requirement. It is envisages that even if closed auctioning is adopted for the requirement fulfillment it would always be best to adopt an open auction approach for financial investor bids to get the best deal for suppliers and resources by encouraging competitive bidding.

The facility will exist in the system for bidders to define and weight different factors such as supplier job references, project or supplier location economic and political stability so that the system can evaluate the cost of the risk based upon their own personal preferences when backing of a project or supplier.

Both open and closed online auctions generally follow the principle that bidders put in a maximum bid but the actual bid placed by the system on behalf of each bidder is the minimum amount to get the bidder into the highest bidder position where possible.

The typical behavior of bidders in an open auction situation is that despite a closing date being set well in advance, many serious bidders will make or change their offers seconds before the auction closes. There are many contributing factors to this behavior such as the rightful assumption made that placing bids earlier encourages other high bids driving the final price higher. In a totally closed auction situation where the bidders and their bids are only visible by the auctioneer this last minute bidding rush is stifled by the lack of information.

In the open auction situation due to the complexity of the requirements and risk factors, the dependency of suppliers bids upon financial investors bids, the requirement to constrain the operating cost of the auction to an acceptable level, the need to coordinate all of the requirements to ensure simultaneous fulfillment of the requirements necessary for the project to progress and the need

This functionality provided by the system cannot be carried out manually for two reasons.
1. Even in a market where the supplier auction was set to a closed bidding format, it is envisaged that the financial investment bidding screen would be set to open bidding as investors would want to be able to increase or decrease their offers based upon other offers. Without the system to carry out the complex calculation defined by the investors to define their personalized market valuations of each opportunity, financials investors would not be able to make market dependant investment decisions based on the latest offers placed. As their decisions are based upon the up front payment offers available to them, the suppliers would not be able to make last minute adjustments to their own offers.
If the task detailed above were carried out manually the end result is that the time that it took to review and inform all of the interested financial bidders of other bids would mean that they would not be able to adjust their bids before the auction closed. This would feed don to suppliers who are depending on offers to place or adjust their bids in the fulfillment of the projects requirements. If they did not bid or increase their bids as a result, this would mean that the resourcer got a worse deal.
2. A typical project phase comprises of many requirements which are themselves broken down into other requirements. To allow a project phase to progress all of the essential requirements need to be fulfilled either directly or by the purchase of resources on the open market. The supply and demand for resources varies continuously and this factor is accentuated as the one major objective of the system is to create a market for redundant stock that may get allocated to another customer order or underutilized assets which may get booked up. The optimal situation where the majority of the resources are fulfilled directly leaving a small number to be purchased on the open market may come and go if it is not possible to set limits and monitor all of the important fulfillment parameters to trigger the acceptance of the current offers by getting legal agreements in place as soon as possible (using online signing where possible).

1. A system adapted to enable plural forms of investment of resources by investors in a project preferably for a primary beneficiary, comprising a processor adapted to enable input by at least one primary user of one or more elements of the project, each element having specified properties and resource requirements, display to a plurality of investors of details of the project and the resource requirements of each of the elements of the project, and input by an investor of details of the availability of one or more of the resource requirements, and wherein the processor is adapted to determine allocation of at least an element of the project to one or more of the investors who have indicated availability of a resource.

2. A system according to claim 1 wherein the processor is adapted to determine relative entitlement of any reward from the project for each of the investors, and preferably wherein the primary user, and/or beneficiary, are able to specify a range of potential rewards for provision of the resource for an element of the project and the system is adapted to optimise fulfillment of the or each element of a project.

3. A system according to claim 2 wherein the relative entitlement of the reward from the project is determined based on a predetermined value of each of the elements to the project compared to a total value of the project, independent of the actual cost of the investment by the investor in an element of a project.

4. A system according to claim 2 wherein the relative entitlement of the reward of the project is determined based on the relative value of a predetermined value of each of the elements to the project compared to a total value of the project, but the relative value is variable depending on the actual cost of the investment by the investor in an element of a project such as increasing interest rates for financial investment.

5. A system according to claim 3 wherein the processor is adapted to vary the relative entitlement of the reward from a project based on variation of the project, preferably due to one or more of variation in the nature of one or more of the elements in the project, the number of elements in the project, and/or the value of the project.

6. A system according to claim 2 wherein the relative entitlement of the reward of a project is determined at least in part from one or more of: payments made by the beneficiary to an investor, retained ownership of a resource, such a machinery or raw materials, by an investor, and level of risk for the investor of the investment.

7. A system according to claim 6 adapted to determine a financial resource requirement for any resource requirement for an element of a project and wherein an investor is able to make a simple financial investment to match a resource requirement.

8. A system according to claim 7 adapted to enable an investor to acquire a group of entitlement rights in one or more projects through matching two or more financial resource requirements.

9. A system according to claim 1 wherein the processor is adapted to manage a plurality of projects.

10. A system according to claim 9 wherein the processor is adapted to display a group of similar resource requirements across two or more projects and to enable an investor to view such resource requirements according to specified categories.

11. A system according to claim 10 wherein the processor is adapted to enable an investor to invest a resource across two or more elements of one or more projects.

12. A system according to claim 9 wherein the processor is adapted to enable an investor to specify types of resource requirements the investor is able to offer and to alert the investor of opportunities within the system, and preferably to alert the investor of new opportunities as new projects are entered on the system.

13. A system according to claim 1 wherein the processor is adapted to enable the primary user to specify properties for an investor and to ensure an investor meets the specified properties before an investor is able to offer a resource for a project.

14. A system according to claim 13 wherein the primary user is able to specify specific investor properties for a project and/or for a specific element of a project.

15. A system according to claim 14 wherein an investor is required to pre-register on the system before being able to propose a resource for an element of a project.

16. A system according to claim 14 wherein the investor properties include one or more of insurance cover to a desired level, previous beneficiary satisfaction ratings, quality rating, and/or competence rating.

17. A system according to claim 1 wherein the processor is adapted to enable two or more primary users to define a project and elements of a project within the system, preferably wherein the primary users are authorised for a specific project, and more preferably wherein the primary users are one or more of the primary beneficiary, two or more beneficiaries of a project, project managers and/or project definers.

18. A system according to claim 1 wherein a time allocation is specified for each project and preferably for each element within a project.

19. A system according to claim 18 adapted to enable commencement of a project upon assignment of all elements to a resource provider, or investor, within a specified time frame of the start of the project.

20. A system according to claim 17 wherein the processor is adapted to vary reward entitlement of a project dependent on provision of a resource by an investor within the specified time allocation of the relevant element and/or project.

21. A system adapted to enable a beneficiary of an investment and/or primary user to provide a satisfaction rating for an investor in a project, and/or to enable an investor, or resource provider, to provide a satisfaction rating of one or more of a project manager, a primary user and/or a beneficiary.

22. A system according to claim 1 wherein the resource requirement is at least one of: financial; human, such as labour, skill, and/or time; material such as raw materials; plant and machinery such as factory, equipment or other physical resource; and accommodation, such as office space and/or warehousing.

23. A system according to claim 1 an investor is able to select one or more reward, or payment, options a low risk and a high risk option such as a fixed allowance for a given project or service at a percentage of profit of the project or part of the project based on the significance of the invested element of that part of or of the project as a whole.

24. A system according to claim 1 adapted to draw information automatically from specified sources thereby to enhance details regarding one or more of a project, an element of a project, an investor, and/or a beneficiary.

25. A system according to claim 24 wherein the information is drawn through a communications network, such as the Internet, and comprises one or more of land registry details, news, estate agent information, surveyors reports, and council information.

26. A system according to claim 1 wherein the processor is adapted to enable input of project details by a beneficiary and display of the project details to two or more project managers, wherein the project managers are able to define elements of the project and the perceived resource requirements of each of the elements and to input these in the system for review by the beneficiary thereby to enable the beneficiary to select a project manager for a project.

27. A system according to claim 26 wherein the beneficiary is able to determine the relative ownership of the project for a selected project manager.

28. A system according to claim 1 adapted to provide a summary of offers of investment, resource provision, for a project thereby to enable determination of remaining available investment opportunities, unfulfilled elements, for a project.

29. A system according to claim 28 wherein the summary is at least in part in the form of a graphical display.

30. A system according to claim 29 wherein in the circumstances of a resource requirement having a specified time allocation, the resource requirement is displayed graphically with temporal separation of the resource requirements.

31. A system according to claim 1 wherein an investor is able to provide a catalogue of resources, such as products and/or services, to the system, preferably comprising an accurate resource descriptor, availability by time and/or date and anticipated reward, and preferably the system is adapted to draw resource allocation automatically from the catalogue according to agreed rules, and more preferably wherein the investor is able to specify resource allocation rules including one or more of beneficiary identity, primary user identity, sector, location and/or country.

32. A system according to claim 31 adapted to automate at least part of the contractual fulfillment of supply of a resource for an element of a project.

33. A system according to claim 1 wherein incremental rights are awarded to an investor depending upon the degree to which a venture underperforms by amounts agreed between the investor or lender and investee.

34. A system according to claim 1 comprising an enabling software solution that facilitates the definition, communication and linking of an offer item to the defined investment opportunity and related item.

35. A system according to claim 1 wherein the resource requirement and/or investment relates to a form of intellectual property right, such as a license under or assignment of such right, preferably allowing predefined use of the brand owned by the investee to allow the sale or hiring out of goods and services offered as security for loaned or invested resource or capital to enable some or all of the value of their value to be recouped by investors or lenders, more preferably allowing an offer that gives investors or lenders a licence to use intellectual property rights held by the investee restricted by territory and usage and financial constrains and time to operate a similar venture in the event that the investees's venture fails to meet targets as agreed between the investors and investees, more preferably wherein the investee receives a royalty from any products or services sold under the licence.

36. A method of enabling collaborative investment in a project comprising the steps of defining a project in terms of elements requiring a resource, defining a method of establishing a reward for investment of the required resources for each of the elements, enabling a plurality of investors to offer to provide a resource for an element of a project for a reward which reward for at least one of the investors is based at least in part on the benefit of the project when completed.
